(19) United States
(12) Patent Application Publication
(10) Pub. No.: US 2010/0316882 A1
(43) Pub. Date: Dec. 16, 2010

(54) NANOMATERIAL AND METHOD FOR GENERATING NANOMATERIAL

(76) Inventors: Andrey V. Filippov, Painted Post, NY (US); Clinton Damon Osterhout, Beaver Dams, NY (US); Martin Andrew Sala, Campbell, NY (US); Kamal Kishore Soni, Painted Post, NY (US); Carlton Maurice Truesdale, Corning, NY (US)

Correspondence Address: CORNING INCORPORATED, SP-TI-3-1, CORNING, NY, 14831, US

(21) Appl. No.: 12/866,832

(22) PCT Filed: Feb. 25, 2009
(86) PCT No.: PCT/US09/01162

§ 371 Date: Aug. 9, 2010

Related U.S. Application Data
(60) Provisional application No. 61/152,480, filed on Feb. 13, 2009.
(60) Provisional application No. 61/066,937, filed on Feb. 25, 2008.

(51) Int. Cl. B32B 15/02; B22F 9/20; B22F 9/30; B05D 1/12; B32B 9/00; B32B 15/04; B29B 9/12

(52) U.S. Cl. 428/548; 75/343; 75/345; 427/180; 428/688; 428/457; 264/10; 977/896

(57) ABSTRACT

Nanomaterial and methods for generating nanomaterial are described wherein a reaction, for example, decomposition, for generating nanomaterial occurs utilizing a hot wall reactor.

This application claims the benefit of priority to U.S. Patent Application No. 61/066,937 filed on Feb. 25, 2008 and to U.S. Patent Application No. 61/152,480 filed on Feb. 13, 2009.

### BACKGROUND

1. Field of the Invention

Embodiments of the invention relate to nanomaterial and methods for generating nanomaterial and more particularly to nanomaterial and methods for generating nanomaterial wherein a decomposition reaction utilizing a hot wall reactor occurs to generate nanomaterial.

2. Technical Background

Over the years, there has been rapid progress in the areas of electronics, materials science, and nanoscale technologies resulting in, for example, smaller devices in electronics, advances in fiber manufacturing and new applications in biotechnology and applications in renewable energy. The ability to generate and collect increasingly smaller, cleaner and more uniform nanomaterial is necessary in order to foster technological advances in areas which utilize small particulate matter and nanomaterial. The development of new, efficient and adaptable ways of producing nanomaterial and subsequently collecting or depositing the nanomaterial onto a substrate becomes more and more advantageous.

The size of a particle often affects the physical and chemical properties of the particle or material comprising the particle. For example, optical, mechanical, biochemical and catalytic properties often change when a particle has cross-sectional dimensions smaller than 200 nanometers (nm). When particle sizes are reduced to smaller than 200 nm, these smaller particles of an element or a material often display properties that are quite different from those of larger particles of the same element or material. For example, a material that is catalytically inactive in the macroscale can behave as a very efficient catalyst when in the form of nanomaterial.

Gas-phase methods of nanomaterial generation are especially attractive, being able to rapidly produce pure thin films and nanoparticles with desirable size range. Aerosol reactors have been developed for the gas-phase synthesis of nano-powders and include, for example, flame reactors, furnace (tubular) reactors, gas-condensation methods, plasma reactors, laser ablation, and spray pyrolysis.

The above-mentioned reactors have several disadvantages, for example, flame reactors and flame spray pyrolysis reactors depend on a combustion process as a source of energy implying the oxidizing environment and presence of highly reactive intermediate combustion products. This restricts the scope of potential precursors and makes synthesis of many materials problematic. The gas-condensation methods are restricted to materials having relatively low vapor pressure, while the plasma reactors often produce aerosols with high polydispersity caused by non-uniform conditions in the reaction zone. Plasma Enhanced Chemical Vapor Deposition (PECVD) is a slow process with deposition rates about 1 nm/s and typically uses expensive precursor materials such as silane or silane containing materials.

It would be advantageous to have nanomaterial produced by decomposition reactions and methods for generating nanomaterial utilizing decomposition reactions.

### SUMMARY

Nanomaterial and methods for generating nanomaterial, as described herein, address one or more of the above-mentioned disadvantages of conventionally made nanomaterial and methods of making nanomaterial and provide one or more of the following advantages: utilization of a hot wall reactor, for example, an induction generator to support decomposition reactions to produce nanomaterial; increased potential for the development of high purity nanomaterial; controlled, repeatable methods; cost effective nanomaterial generation; continuous flow of precursors with a low positive pressure or decomposition reactions at atmospheric pressure; and/or substantially higher deposition rates as compared to conventional methods, for example, PECVD (1 nm/s).

The decomposition reaction capability expands the potential gas-phase synthesis of hot wall reactors to support reactions minimizing oxidizing agents to make nanomaterial, for example, metals.

One embodiment is a method for generating nanomaterial. The method comprises providing a flow of a precursor material through an inlet of a hot wall reactor, heating the precursor material in the hot wall reactor, and producing nanomaterial by decomposition of the precursor material.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework for understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawing figures.

FIG. 1a is a schematic of a hot wall reactor according to one embodiment.

FIG. 1b is a schematic of a hot wall reactor according to one embodiment.

FIG. 1c is a schematic of a hot wall reactor according to one embodiment.

FIG. 2 is a transmission electron microscopy (TEM) micrograph of a composite comprising silicon nanowires made according to one embodiment.

### DETAILED DESCRIPTION

In conventional methods of making particles using hot wall reactors, gaseous precursor material is supplied from one end of the hot wall reactor and is heated by thermal conductivity from the walls of the hot wall reactor to a temperature necessary for initiating and maintaining a chemical reaction. The chemical reaction(s) occur(s) inside the hot wall reactor in the presence of oxidizing agents, for example, oxygen, and particles subsequently exit the opposite end of the hot wall reactor.

Typically, in the case when all precursor material is mixed initially, the chemical reaction starts in the location where the necessary reaction temperature is reached, yielding vapors of desired material. When conditions for vapor condensation are reached, the resulting material nucleates and condenses, forming aerosol particles. The particle sizes are typically in the range between several nanometers and some hundred nanometers, provided the conditions for particle agglomeration are there, such as high enough concentration of aerosol monomers.

Reference will now be made in detail to various embodiments of the invention, examples of which are illustrated in the accompanying drawings. Wherever possible, the same reference numbers will be used throughout the drawings to refer to the same or like parts.

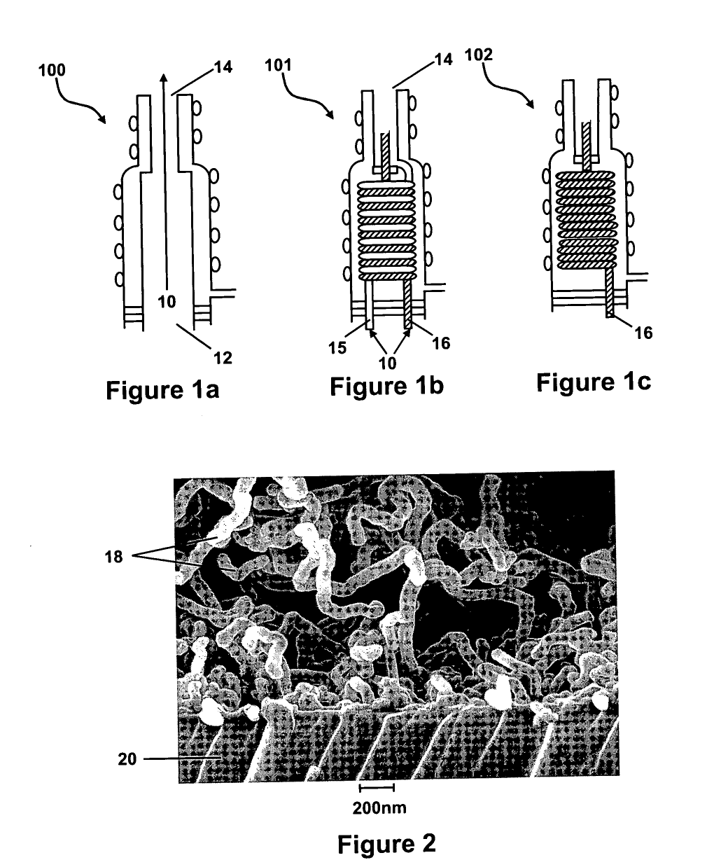

One embodiment of the invention is a method for generating nanomaterial. As shown in FIG. 1a, the method comprises providing a flow of a precursor material 10 through an inlet 12 of a hot wall reactor 100, heating the precursor material in the hot wall reactor, and producing nanomaterial by decomposition of the precursor material.

According to one embodiment, the decomposition occurs in the hot wall reactor 100. In another embodiment, the decomposition occurs after the precursor material exits an outlet 14 of the hot wall reactor. In yet another embodiment, the decomposition occurs both in the hot wall reactor and after an unreacted portion of precursor material exits an outlet of the hot wall reactor.

The precursor material, according to one embodiment, comprises a metal halide, boron trichloride, a hydride, ammonia, a carbon based precursor, methane, carbon tetrachloride, phosphorous pentachloride, phosphorous trichloride, hydrogen sulfide. In one embodiment, the metal halide is silicon tetrachloride. The precursor material can be selected so as to produce the desired nanomaterial upon decomposition, for example, a metal halide such as SiCl₄ or TiCl₄ can be used to produce silicon and titanium respectively.

In one embodiment, the nanomaterial comprises a metal, a non-oxide metal, an alloy, or combinations thereof. The nanomaterial can comprise, for example, silicon, copper, titanium, zirconium, germanium, rare earth metals such as lanthanum, gold, chromium, iron, silicon compounds (for instance silicon carbide, silicon nitride, and SiGe), and combinations thereof.

The non-oxide metal can comprise a boride, a sulfide, a nitride, a carbide, a phosphide, or combinations thereof.

In one embodiment, the hot wall reactor is selected from an induction generator, an electromagnetic generator, and combinations thereof. A conventional electromagnetic generator has at least one susceptor, wherein the susceptor material is selected from the group consisting of platinum, rhodium, graphite, and a platinum\rhodium compound and is capable of being acted upon by electromagnetic energy, generating heat and being disposed such that heat is applied to the interior space defined by the walls of the generator.

In one embodiment, the hot wall reactor is an induction generator. In an induction generator, the susceptor material is heated using inductive heating elements. As used herein the term “susceptor” refers to any material capable of generating heat when acted upon by energy from an energy source.

Hot wall reactors, for example, electromagnetic generators and induction generators, are described in U.S. patent application Ser. No. 11/502,286, filed on Aug. 10, 2006, and can receive the provided flow of precursor material and be used in accordance with the methods described herein.

The method, in one embodiment, further comprises providing two or more flows of the precursor material. The two or more flows can be provided using two or more hot wall reactors. When two or more hot wall reactors are used, the precursor material is heated in their respective hot wall reactors. The heated precursor material can react in their respective hot wall reactors or can enter a common enclosure where the precursor materials mix, and react after exiting the outlets of the hot wall reactors. According to some embodiments, the two or more flows can comprise the same precursor material or the two or more flows can comprise different precursor material.

In one embodiment, as shown in FIG. 1b, the two or more flows 10 are provided within one hot wall reactor 101. In this embodiment, the precursor material in the hot wall reactor is heated to prescribed temperatures in separate delivery lines 15 and 16. The delivery lines/susceptors can be made of a material, for example, selected from platinum, rhodium, or a platinum\rhodium compound. The delivery lines can be, for example, straight tubes or can be coiled into a helical configuration. Decomposition of the precursor materials can occur in the delivery lines or, in some embodiments, after exiting an outlet 14 of the hot wall reactor to produce nanomaterial.

In one embodiment, as shown in FIG. 1c, one hot wall reactor 102 can be used to produce a flow of precursor material. In this embodiment, the precursor material in the hot wall reactor is heated to prescribed temperatures in a single delivery line 16. The delivery line can be made of a material, for example, selected from platinum, rhodium, or a platinum\rhodium compound. The delivery line can be, for example, a straight tube or can be coiled into a helical configuration. In this embodiment, the flow can comprise a single precursor material or can comprise multiple species of precursor material.

The method, according to one embodiment, comprises heating the precursor material in the presence of a gas selected from argon, nitrogen, helium, hydrogen, and combinations thereof. According to one embodiment, the gas is argon. According to another embodiment, the gas is a combination of argon and hydrogen, for example, 80 percent argon and 2 percent hydrogen. In one embodiment, the precursor material can be heated at a temperature of 1600 degrees Celsius or less, for example, 1400 degrees Celcius or less from 1200 degrees Celsius to 1400 degrees Celsius, for example from 1280 degrees Celsius to 1350 degrees Celsius.

The method, according to another embodiment, comprises introducing a gas selected from argon, nitrogen, helium, hydrogen, and combinations thereof at an outlet of the hot wall reactor.

According to another embodiment, the gas is introduced both in the hot wall reactor and at an outlet of the hot wall reactor.

In one embodiment, the nanomaterial is in the form of nanoparticles, nanostructures, or combinations thereof.

In one embodiment, the method further comprises collecting the nanomaterial, for example, the nanomaterial can be deposited onto a substrate. The substrate, according to one embodiment, is selected from a slide, a conductive sheet, a non-conductive sheet, glass, ceramic, and combinations thereof. The nanomaterial can be bulk collected, for example, in powder form.

The nanomaterial, according to one embodiment, is in the form of nanoparticles, a film, nanostructures, a nanostructured film or combinations thereof. In one embodiment, the forms can be layered, for example, a layer of nanoparticles over a film over a layer of nanostructures (for instance, nanotubes, nanowires, nanostructured films having some morphology). The compositions and form of any of the layers or within an individual layer can be the same or can be different.

The method can further comprise cooling the precursor material or the nanomaterial after exiting the outlet of the hot wall reactor. The precursor material or the nanomaterial can be cooled by conducting the reaction in an actively cooled enclosure. The enclosure can comprise quartz. The quartz can be in a stainless steel jacket. The enclosure can be cooled, for example, by flowing a coolant selected from water, antifreeze, and a combination thereof through the jacket. The temperature of the coolant in a supply reservoir can be, for example, from below zero degrees Celsius to 25 degrees Celsius. In one embodiment, substrates placed in the enclosure are also cooled as a result of the enclosure being cooled.

In one embodiment, cooling comprises quenching the reaction zone. A quench refers to a rapid cooling. Quenching can be used to prevent low-temperature processes such as phase transformations from occurring by only providing a narrow window of time in which the reaction is both thermodynamically favorable and kinetically accessible.

Cooling, in one embodiment, is active cooling. According to another embodiment, cooling or quenching is a result of the precursor material and or the nanomaterial exiting the heated hot wall reactor optionally entering an enclosure having a unheated gas flow such as argon and hydrogen.

The method can further comprise heating the precursor material or the nanomaterial after exiting the outlet of the hot wall reactor. The precursor material or the nanomaterial can be heated by conducting the reaction in a heated enclosure. The enclosure, in one embodiment, comprises quartz. The quartz can be in a stainless steel jacket. The enclosure can be heated, by flowing a heated liquid, for example, water through the jacket. In another embodiment, the enclosure comprises quartz and graphite and is inductively heated. The enclosure can be heated at temperature of 1500 degrees Celsius or less, for example, 800 degrees Celsius or less, for example, 400 degrees Celsius or less, for example, from 100 degrees Celsius to 400 degrees Celsius. In one embodiment, substrates placed in the enclosure are also heated as a result of the enclosure being heated.

Another embodiment is a nanomaterial made by any of the methods described above, such as by providing a flow of a precursor material through an inlet of a hot wall reactor, heating the precursor material in the hot wall reactor, and producing nanomaterial by decomposition of the precursor material. The nanomaterial can be in the form of nanoparticles, nanowires, or combinations thereof. According to this embodiment, the nanomaterial can be bulk collected.

According to another embodiment, a composite comprising nanomaterial on a substrate is made by providing a flow of a precursor material through an inlet of a hot wall reactor, heating the precursor material in the hot wall reactor, and producing nanomaterial by decomposition of the precursor material. In one embodiment, the composite can be in the form of form of nanoparticles, a film, nanostructures, a nanostructured film or combinations thereof. According to one embodiment, the composite can be layered, for example, a layer of nanoparticles over a film over a layer of nanostructures (for instance, nanotubes, nanowires, nanostructured films having some morphology). The compositions and form of any of the layers or within an individual layer can be the same or can be different.

According to one embodiment, a composite comprising metal nanowires, such as silicon nanowires, can be made according to the described methods. FIG. 2 is a transmission electron microscopy (TEM) micrograph of a composite comprising silicon nanowires 18 on a non-conductive substrate 20 made according to one embodiment

According to one embodiment, a composite comprising a metal film, such as a silicon film on a substrate can be made according to the methods described herein. The metal film, such as a silicon film, according to some embodiments is amorphous, nanocrystalline, multi-crystalline, or combinations thereof. In a multi-crystalline metal film, such as a silicon film, both nanocrystalline and polycrystalline material can be present.

In one embodiment, the composite comprises multiple metal films, such as a silicon films, for example, an amorphous silicon film and a nanocrystalline silicon film. In one embodiment, the silicon film comprises hydrogen, chlorine, or combinations thereof.

In one embodiment, the composite comprises a nanomaterial alloy film, such as a metal alloy film such as a silicon alloy film or a nanomaterial film such as a metal film such as a silicon film made according to the methods described herein; and doped with boron or phosphorous.

One embodiment is a nanomaterial film, for example, a metal film such as silicon film comprising nanocrystalline nanomaterial, for example, nanocrystalline metal such as nanocrystalline silicon; and hydrogen, chlorine, or combinations thereof. The silicon can be, in one embodiment, in the range of from 40 percent to 95 percent nanocrystalline. According to another embodiment, the silicon can be 85 percent or above nanocrystalline, for example, above 85 percent nanocrystalline.

According to another embodiment, the metal film, such as a silicon film, can be substantially amorphous and comprise hydrogen, chlorine, or combinations thereof. Hydrogen may be introduced into the film, for example, by virtue of contact of precursor material with hydrogen gas, or by virtue of hydrogen being a byproduct of the decomposition reaction. Chlorine may be introduced into the film, for example, by virtue of the presence of chlorine in the precursor material, for example, a metal halide such as SiCl₄.

The atomic percent of chlorine in the silicon film can be, for example, in the range of from 0.1 atomic percent to 10 atomic percent. The atomic percent of hydrogen in the silicon film can be, according to one embodiment, 40 atomic percent or less, for example, 30 atomic percent or less. In another embodiment, the atomic percent of hydrogen can be greater than zero, for example, greater than zero to 20 atomic percent.

### EXAMPLES

A flow of a precursor material, in this example, SiCl₄ with argon, or argon and hydrogen was provided through an inlet of a hot wall reactor, in this example, an induction generator. When argon and hydrogen were used, the gas mixture was 80 percent argon and 2 percent hydrogen. The flow rate of the argon/hydrogen was 4.00 liters/minute (l/min), in this example, but could be adjusted depending on the composition of the precursor material. The precursor material was heated within the induction generator at a temperature of 1340 degrees Celsius. An 80 percent argon and 2 percent hydrogen gas mixture was introduced at an outlet of the hot wall reactor into an enclosure at a flow rate in the range of from 1(l/min) to 2(l/min), and produced nanomaterial, in this example, silicon by decomposition of the precursor material. In the same enclosure, the nanomaterial was deposited onto substrates, in this example, non-conductive sheets, for example, glass. The deposition rate was, for example, 3 nm/s. The examples were performed at atmospheric pressure.

According to one example, the decomposition occurred in the induction reactor. In another example, the decomposition occurred after the precursor material exited an outlet of the induction reactor.

The crystallinity of the nanocrystalline film and the size of the crystallites were determined using X-ray diffraction and Raman spectroscopy. The average diameter of the crystallites was found to be in the range of from 10 nanometers to 15 nanometers. The fraction of the crystalline phase was determined using Raman spectroscopy and varied in the range of from 40 percent to 95 percent with a typical value of 85% or above.

Nanomaterial and nanomaterial made according to the methods described herein are useful for, for example, semiconductor, optoelectronic, photocatalysis, and display applications.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A method for generating nanomaterial, the method comprising:
providing a flow of a precursor material through an inlet of a hot wall reactor;
heating the precursor material in the hot wall reactor; and
producing nanomaterial by decomposition of the precursor material.

2. The method according to claim 1, wherein the decomposition occurs in the hot wall reactor.

3. The method according to claim 1, wherein the decomposition occurs after the precursor material exits an outlet of the hot wall reactor.

4. The method according to claim 1, wherein the hot wall reactor is selected from an induction generator, an electromagnetic generator, and combinations thereof.

5. The method according to claim 1, comprising heating the precursor material in the presence of a gas selected from argon, nitrogen, helium, hydrogen, and combinations thereof.

6. The method according to claim 1, comprising introducing a gas selected from argon, nitrogen, helium, hydrogen, and combinations thereof at an outlet of the hot wall reactor.

7. The method according to claim 1, wherein the nanomaterial comprises a metal, a non-oxide metal, an alloy, or combinations thereof.

8. The method according to claim 7, wherein the non-oxide metal comprises a boride, a sulfide, a nitride, a carbide, a phosphide, or combinations thereof.

9. The method according to claim 1, wherein the nanomaterial is in the form of nanoparticles, nanostructures, or combinations thereof.

10. The method according to claim 1, wherein the precursor material comprises a metal halide, boron trichloride, a hydride, ammonia, a carbon based precursor, methane, carbon tetrachloride, phosphorous pentachloride, phosphorous trichloride, hydrogen sulfide.

11. (canceled)

12. The method according to claim 1, further comprising collecting the nanomaterial.

13. The method according to claim 12, wherein collecting the nanomaterial comprises depositing the nanomaterial onto a substrate.

14. (canceled)

15. (canceled)

16. The method according to claim 1, further comprising cooling the precursor material or the nanomaterial after exiting the outlet of the hot wall reactor.

17. The method according to claim 1, further comprising heating the precursor material or the nanomaterial after exiting the outlet of the hot wall reactor.

18. Nanomaterial made according to claim 1.

19. A composite comprising the nanomaterial made according to claim 1 on a substrate.

20. A composite comprising a nanomaterial film made according to claim 1 on a substrate.

21. The composite according to claim 20, wherein the nanomaterial film is amorphous, nanocrystalline, multi-crystalline, or combinations thereof.

22. The composite according to claim 20, wherein the nanomaterial film comprises hydrogen, chlorine, or combinations thereof.

23. A composite comprising a nanomaterial alloy film or nanomaterial film made according to claim 1; and doped with boron or phosphorous.

24. A composite comprising nanomaterial nanowires made according to claim 1.

25. A nanomaterial film comprising nanocrystalline nanomaterial; and hydrogen, chlorine, or combinations thereof.

26-29. (canceled)
